(19) United States
(12) Patent Application Publication
(10) Pub. No.: US 2015/0324994 A1
(43) Pub. Date: Nov. 12, 2015

(54) Method of Automatically Calculating Linking Strength of Brain Fiber Tracts

(71) Applicant: National Taiwan University, Taipei (TW)

(72) Inventors: Wen-Yih TSENG, Taipei (TW); Sung-Chieh LIU, Taipei (TW); Yu-Jen CHEN, Taipei (TW); Yao-Chia SHIH, Taipei (TW)

(21) Appl. No.: 14/506,365

(22) Filed: Oct. 3, 2014

(30) Foreign Application Priority Data
May 12, 2014 (TW) 103116654

(51) Int. Cl. G06T 7/00

(52) U.S. Cl. CPC G06T 7/0081; G06T 7/0002; G06T 7/0028; G06T 2207/10092; G06T 2207/20141; G06T 2207/30016

(57) ABSTRACT

The invention provides a method of automatically calculating a linking strength of brain fiber tracts. The method includes the steps as follows: providing a brain reference template with a plurality of reference fiber bundles; providing an object image with an image information; co-registering the image information according to the brain reference template, deforming and mapping the reference fiber bundles on the object image, so as to make the object image have a plurality of clear object fiber bundles; defining a plurality of regions of interest (ROIs) from the object image, analyzing and calculating a number and a length of the object fiber bundles between each two ROIs, and obtaining a plurality of mean object information from connections between the ROIs; dividing the number by the length, and then multiplying a value above by the mean object information to generate a plurality of link strength values of connections between the ROIs used to be made as a matrix image.

### CROSS-REFERENCE TO RELATED APPLICATIONS

This Non-provisional application claims priority under 35 U.S.C. §119(a) on Patent Application No(s). [TW103116654] filed in Taiwan, Republic of China [May, 12, 2014], the entire contents of which are hereby incorporated by reference.

### FIELD OF THE INVENTION

The invention is related to an analyzing method, more particularly to a method of automatically calculating linking strength of brain fiber tracts.

### BACKGROUND OF THE INVENTION

Traditionally, there are four steps to establish the linking relationship of brain fibers from the diffusion Magnetic Resonance Imaging technology signal. The four steps are: 1. Diffusion MRI data is captured by the 3T MRI system. 2. A white matter tractography diagram is reconstructed based on the post-processing method of a diffusion map to construct a largest diffusion coherent 3-dimensional random curve. 3. The white and gray matter borders are divided to define a number of different regions of interest (ROIs) based on the empirical law. 4. The connectivity network is constructed according to the direct linking strength between ROIs related to the white matter tractography diagram.

However, the traditional method above produces a large number of neuron fibers, nodes and edges of the linking relationship of brain fibers; it not only extends the computing time, but also increases the space complexity. The traditional method only considers the direct linking strength between ROIs, but ignores the indirect linking strength between ROIs. It is not in conformity with the anatomical knowledge. Therefore, the result is useless to be a clinical evidence.

Finally, the present invention provides a method of automatically calculating linking strength of brain fiber tracts to overcome defects of the traditional techniques.

### SUMMARY OF THE INVENTION

The invention provides a method of automatically calculating the linking strength of brain fiber tracts, and comprises the steps as follows:

Step1. A brain reference template with a plurality of reference fiber bundles is provided.

Step2. An object image with an image information is provided.

Step3. The image information is co-registered according to the brain reference template. The reference fiber bundles are deformed and mapped on the object image. Therefore, the object image can have a plurality of clear object fiber bundles.

Step4. A plurality of regions of interest (ROIs) are defined from the object image, a number and a length of the object fiber bundles between each two ROIs are analyzed and calculated, and obtaining a plurality of mean object information from connections between the ROIs.

Step5. The number of the object fiber bundles are divided by the length respectively, and then multiplied by the mean object information to generate a plurality of linking strength values of connections between the ROIs.

Step6. The linking strength values of connections between the ROIs are made as a matrix image, which is not limited herein.

The method of automatically calculating the linking strength of brain fiber tracts can arrange connections between each two ROIs of the object image according to different brain regions in a whole brain. The linking strength values of connections between different brain regions can be presented by different colors. Furthermore, users can made the matrix image about the linking strength of brain fiber tracts. It can be clear to show a combination of the linking strength of direct connections and indirect connections between each two ROIs from the matrix image. The matrix image not only can illustrate the complex neural structure of the whole brain, but also can be a data of the clinical comparison or the neuroscience research.

### BRIEF DESCRIPTION OF THE DRAWINGS

FIG. 1 shows a flow chart of the method of automatically calculating the linking strength of brain fiber tracts.

FIG. 2 shows a diagram of the step 1.

FIG. 3 shows a diagram of the step 3.

FIG. 4 shows an object image have a plurality of object fiber bundles which are deformed and mapped from the brain reference template.

FIG. 5A shows a matrix image made by the linking strength values of direct connections of the object fiber bundles.

FIG. 5B shows a matrix image made by the linking strength values of direct connections and first-ordered indirect connections of the object fiber bundles.

FIG. 5C shows a matrix image made by the linking strength values of direct connections, first-ordered and second-ordered indirect connections of the object fiber bundles.

FIG. 6A shows a matrix image made by direct connections, first-ordered and second-ordered indirect connections between each two ROIs in a whole brain.

FIG. 6B shows a matrix image made by direct connections, first-ordered and second-ordered indirect connections between each two ROIs in a whole brain which are arranged according to different brain regions.

FIG. 7 shows a box diagram (box plot) of reliability verification of Pearson correlation coefficient by calculating results of the linking strength.

### DETAILED DESCRIPTION OF THE INVENTION

For clarity of disclosure, and not by way of limitation, the detailed description of the invention is disclosed in the follow subsections.

The present invention provides a method of automatically calculating the linking strength of brain fiber tracts. The method is used to analyze signals obtained from an object image and co-operate with a brain reference template 11 to estimate nerve fiber links of a whole brain. The comparing of connection matrix between each two regions of interest (ROIs) in the whole brain is beneficial to estimate the possibility of lesions, such as Alzheimer's disease, or to estimate the recovery of brain situation of a patient.

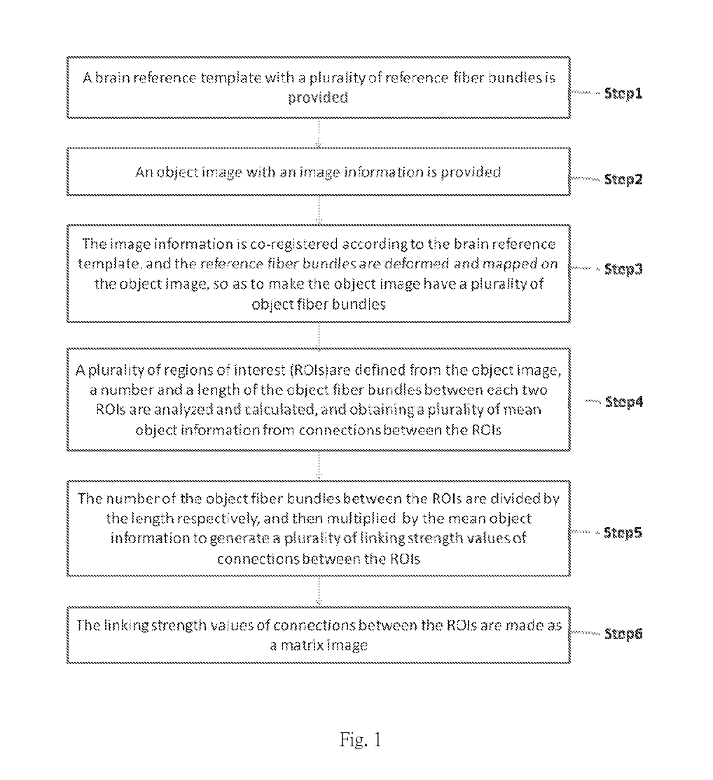

FIG. 1 shows a flow chart of the method of automatically calculating the linking strength of brain fiber tracts, the method of automatically calculating the linking strength of brain fiber tracts in the present invention comprises the steps as follows:

Step1. A brain reference template 11 with a plurality of reference fiber bundles 12 is provided.

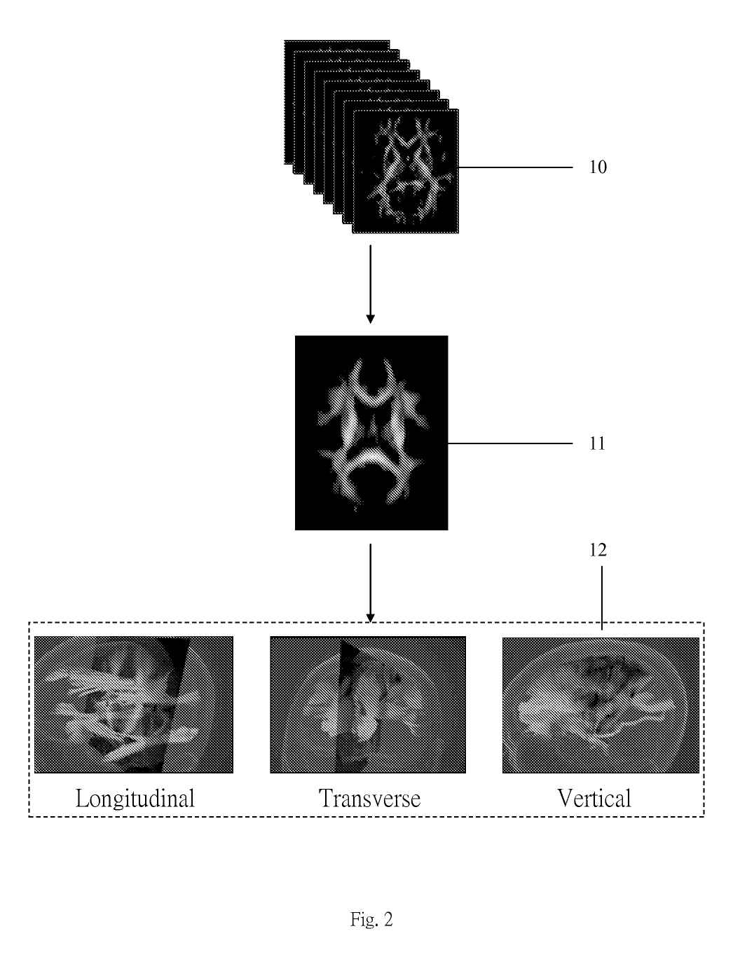

In an embodiment, FIG. 2 shows a diagram of the Step 1. The brain reference template 11 is generated by using the method of LDDMM to analyze and co-register a plurality of normal brain images 10. The normal brain images 10 are Diffusion Spectrum Imaging (DSI) or Diffusion Tensor Imaging (DTI), which is not limited herein.

The method of LDDMM is used to simulate the mapping process as the flow of liquid, and define a difference function between two images to derive the shortest path between two images. As a result, it can use a linear analysis to process nonlinear anatomical images with high variation in the same coordinate space.

LDDMM is a contraposition method according to a structure data, the image may be deformed during the contraposition process, but the information of transformed data is still remained. For example, a transformed brain image still remains the information of original brain fiber tracts.

In the clinical study, although the homology structures of different objects are different, the shapes of them are similar, and they have the same data structure. The deformed image, by LDDMM, may be remained the internal connection and the adjacent relationship of structures. It's suitable for being used as the brain reference template 11.

Then, the brain reference template 11 is reconstructed to generate the reference fiber tracts 12. In an embodiment, the reference fiber tracts 12 can be a plurality of white matter fiber atlas in the brain, which is not limited herein. In an embodiment, as FIG. 2 showing, the brain reference template 11 is reconstructed by a fiber tractography method, which is not limited herein.

The signals of the brain reference template 11 can be strengthened by cumulating a plurality of normal brain images 10. Therefore, each reference fiber tracts 12 can be shown clearly.

Step2. An object image 20 with an image information is provided. For example, the image information can be a plurality of pixels that comprise the coordinate information and the numerical information, which is not limited herein.

Step3. The image information is co-registered according to the brain reference template 11, and the reference fiber bundles 12 are deformed and mapped on the object image 20, so as to make the object image 20 have plurality of object fiber bundles 21.

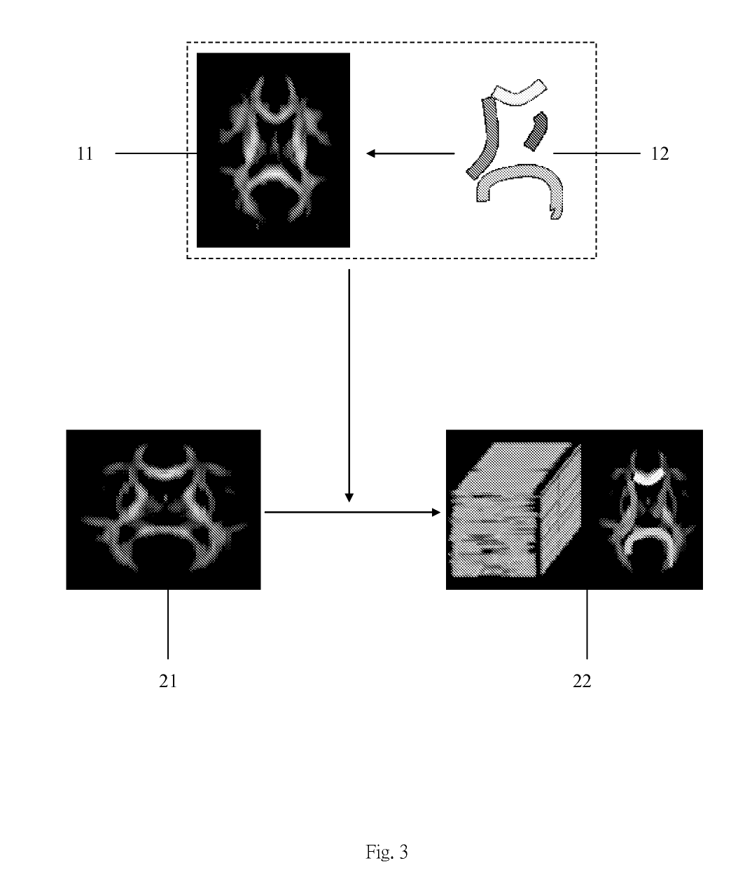

In an embodiment, FIG. 3 is a diagram showing the step 3 in the invention. The object image 20 is co-registered according to the brain reference template 11 by using LDDMM. The reference fiber bundles 12 can be deformed and mapped on the object image 20 according to the co-registering result above, so as to make the object image 20 have object fiber bundles 21.

Because the signals of the object image 20 are too weak, it is hard to calculate to generate every complete object fiber bundles 21. The object fiber bundles 21 obtained from sampling the brain reference template 11 to the reference fiber tracts 12 can include a plurality of related information according to the locations information, which is not limited herein.

Step4. A plurality of ROIs are defined from the object image, a number and a length of the object fiber bundles 21 between each two ROIs are analyzed and calculated, and obtaining a plurality of mean object information from connections between the ROIs.

Because the nerve fiber connections are directional in three-dimensional space, an orientation distribution function can be taken to show the information. In an embodiment, Generalized Fractional Anisotropy (GFA) can be taken to show all the object information of each object fiber bundle 21. Moreover, GFA can represent the anisotropism of the fiber tracts, the larger value of GFA represents the stronger anisotropism of distribution, and represents the fiber tracts are more anisotropic. If it is represented by eigenvector, the object information of the invention also can be FA, which is not limited herein.

There are a plurality of information of the object fiber bundle 21 at a direct connection between two ROIs. The information are summed up and averaged to obtain an average object information of the direct connection, mean Generalized Fractional Anisotropy (mGFA).

Step5. The number of the object fiber bundles are divided by the length respectively, and then multiplied by the mean object information to generate a plurality of linking strength values of connections between the ROIs.

In an embodiment, connections between the ROIs are direct connections of the object fiber bundles 21 between any two ROIs. That is to say, the direct connections mean the connections between any two ROIs only through one object fiber bundle 21.

In another embodiment, the connections between the ROIs are direct or indirect connections with multi-orders of the object fiber bundles 21 between any two ROIs. That is to say, the direct connections or the indirect connections mean the connections between any two ROIs through one object fiber bundle 21 or the combination of a plurality of the object fiber bundles 21 (such as first-ordered indirect links, second-ordered indirect links, etc.).

Step6. The links strength values of connections between the ROIs are made as a matrix image or a brain connection image, which is not limited herein.

In an embodiment, the linking strength of connections between the ROIs can be analyzed to provide follow-up information, for example, the connections between the ROIs can be analyzed to provide combination information of neurons in the brain, if when the existing synapses or connections appear strength change, its ability to transmit information is also changed, then this information can provide physicians to be used in an examination.

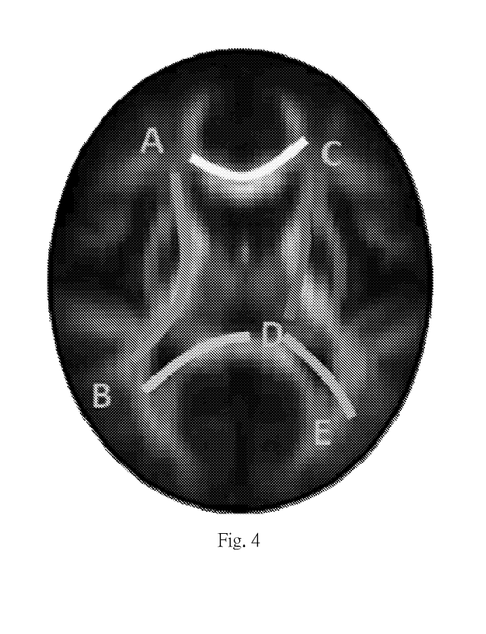

In an embodiment, please refer to FIG. 4, showing a diagram of the object fiber bundles 21 obtained from the object image 20 according to the contraposition of the brain reference template 11. It is assumed that the object image 20 includes a plurality of ROIs A [symbol] B [symbol] C [symbol] D [symbol] E. The linking strength value of connection between the ROI A and B can be obtained through the number_{(AB)} of the object fiber bundles 21 of connection between the ROI A and B be divided by the length_{(AB)}, and then multiplied the mGFA_{(AB)} to generate the linking strength values SC_{(AB)} of connection between the ROI A and B.

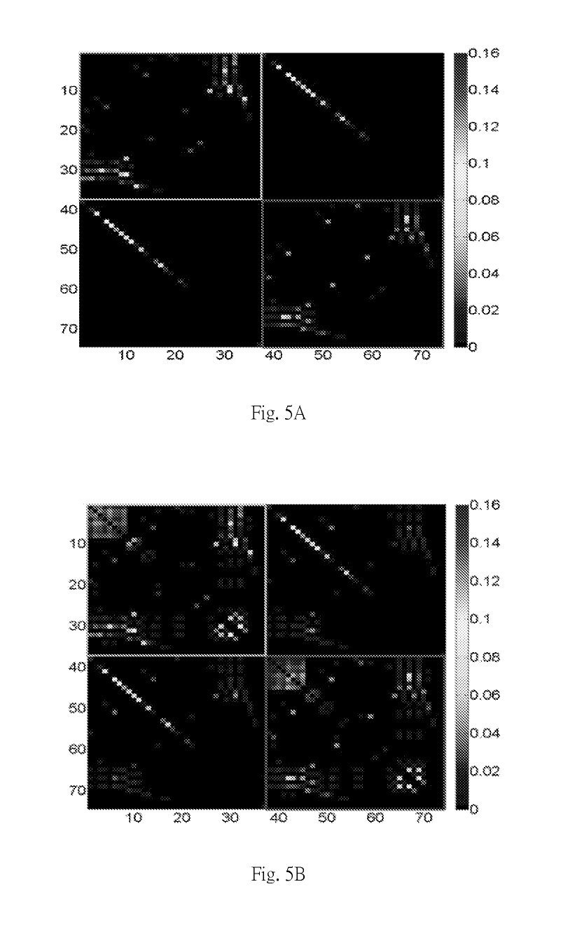

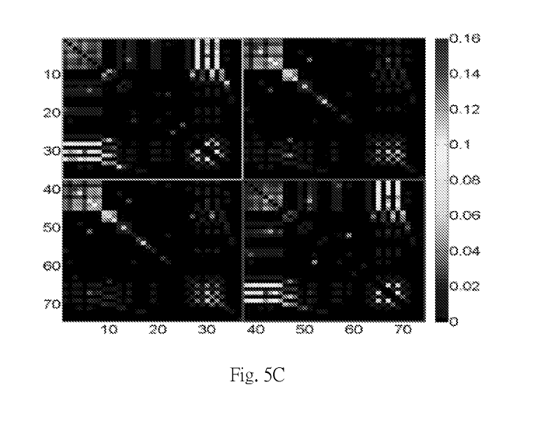

By repeating the steps above, the linking strength values SC_{(AC)} [symbol] SC_{(BD)} [symbol] SC_{(DE)} [symbol] SC_{(CD)} of the ROIs also can be obtained, which belongs to the direct connections of the object fiber bundles 21 between any two ROIs. Please refer to FIG. 5A, showing a matrix image made by the linking strength values of direct connections of the object fiber bundles 21, which is not limited herein.

By repeating the steps above, the linking strength values SC_{(ACD)} [symbol] SC_{(ABD)} [symbol] SC_{(CDE)} [symbol] SC_{(CDB)} [symbol] SC_{(BDE)} [symbol] SC_{(BAC)} of connections between the ROIs also can be obtained, which belongs to the first-ordered indirect connections of the object fiber bundles 21 between any two ROIs. Please refer to FIG. 5B, showing a matrix image made by the linking strength values of direct connections and first-ordered indirect connections of the object fiber bundles 21, which is not limited thereto.

By repeating the steps above, the linking strength values SC_{(ABDE)} [symbol] SC_{(ABDC)} [symbol] SC_{(CABD)} [symbol] SC_{(ABDE)} [symbol] SC_{(ACDE)}of connections between the ROIs also can be obtained, which belongs to the second-ordered indirect connections of the object fiber bundles 21 between any two ROIs. Please refer to FIG. 5C, showing a matrix image made by the linking strength values of direct connections, first-ordered and second-ordered indirect connections of the object fiber bundles 21, which is not limited herein.

In an embodiment of the first-ordered indirect connections between two ROIs, the linking strength value of connection between the ROI A and D can be obtained by the equation: 1/SC_{(ACD)}=1/SC_{(AC)}+1/SC_{(CD)}, 1/ SC_{(ABD)}=1/SC_{(AB)}+1/SC_{(BD)} and SC_{(AD)}=SC_{(ACD)}+SC_{(ABD)}, which taking the connection of the object fiber bundles 21 is similar to the series circuits and the parallel circuits of electrical conductance. Then the linking strength value SC_{(AD)} can be obtained, which is not limited herein.

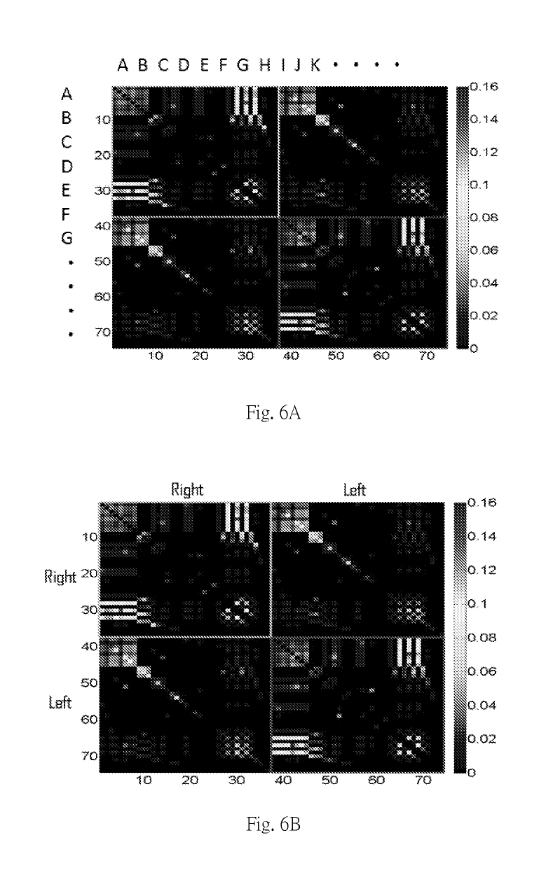

In addition, please refer to FIG. 6A, showing a matrix image made by the first-ordered and the second-ordered indirect connections of the ROIs in the whole brain. The method of automatically calculating the linking strength of brain fiber tracts can arrange the ROIs of the object image 20 in accordance with different brain regions (A, B, C, D . . . ). The linking strength values of connections of different brain regions are presented by different colors, and establish the matrix image of the linking strength values of nerve fiber connections within the whole brain.

Please refer to FIG. 6B, showing a matrix image made by the direct connections, the first-ordered and the second-ordered indirect connections of the ROIs in the whole brain. It can be clear to show a combination of the linking strength of direct connections, first-ordered and second-ordered indirect connections between each. ROIs from the matrix image of the whole brain. The matrix image not only can illustrate the complex neural structure of the brain, but also be a data of the clinical comparison or the neuroscience research.

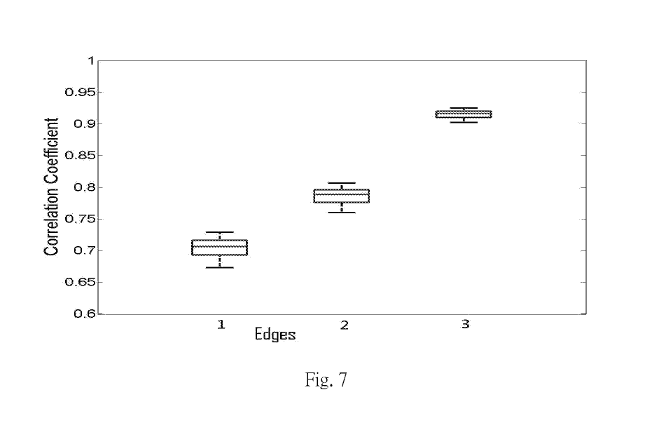

As FIG. 7 showing, the box plot illustrates the reliability verified through person correlation coefficient by calculating the results of linking strength for 20 experimental individuals. Comparing with the prior art, the present invention has better reliable performance because of jointing the direct and indirect connection relationships between the ROIs.

Although the present invention has been described in term of embodiments, it will be appreciated that the embodiments disclosed herein are for illustrative purposes only and various modifications and alterations might be made by those skilled in the art without departing from the spirit and scope of the invention as set forth in the following claims.

What is claimed is:

1. A method of automatically calculating linking strength of brain fiber tracts, comprising:
Step1. providing a brain reference template with a plurality of reference fiber bundles;
Step2. providing an object image with an image information;
Step3. co-registering the image information according to the brain reference template, deforming and mapping the reference fiber bundles on the object image, so as to make the object image have a plurality of object fiber bundles;
Step4. defining a plurality of regions of interest (ROIs) from the object image, analyzing and calculating a number and a length of the object fiber bundles between each two ROIs, and obtaining a plurality of mean object information from connections between the ROIs; and
Step5. dividing the number by the length, and then multiplying a value above by the mean object information to generate a plurality of linking strength values of connections between the ROIs.

2. The method of automatically calculating the linking strength of brain fiber tracts according to claim 1, wherein the brain reference template is generated by using Large Deformation Diffeomorphic Metric Mapping (LDDMM) to analyze and co-register a plurality of normal brain images.

3. The method of automatically calculating the linking strength of brain fiber tracts according to claim 2, wherein the normal brain images are Diffusion Spectrum Imaging (DSI) or Diffusion Tensor Imaging (DTI).

4. The method of automatically calculating the linking strength of brain fiber tracts according to claim 1, wherein the brain reference template is reconstructed by a fiber tractography method to generate the reference fiber tracts.

5. The method of automatically calculating the linking strength of brain fiber tracts according to claim 1, wherein the mean object information are information of mean Generalized Fractional Anisotropy (mGFA) or information of mean Fractional Anisotropy (mFA).

6. The method of automatically calculating the linking strength of brain fiber tracts according to claim 1, wherein in Step3, the object image is generated according to the brain reference template by LDDMM.

7. The method of automatically calculating the linking strength of brain fiber tracts according to claim 1, wherein the connections between ROIs are direct connections between any two ROIs.

8. The method of automatically calculating the linking strength of brain fiber tracts according to claim 1, wherein the connections between ROIs are direct connections and indirect connection with multi-orders between any two ROIs.

9. The method of automatically calculating the linking strength of brain fiber tracts according to claim 1, further comprising step6, the linking strength values of connections between the ROIs are made as a matrix image.
